(19) United States
(12) Patent Application Publication
(10) Pub. No.: US 2022/0174221 A1
(43) Pub. Date: Jun. 2, 2022

(54) CAMERA IN BRACKET AND METHOD TO MINIMIZE BLIND SPOTS TO THE TRANSMISSION OF ANTENNA SIGNALS

(71) Applicant: Multiwave Sensors Inc., Bolton (CA)

(72) Inventors: Mark Frischman, Thornhill (CA); Bruce Kenneth Clifford, Brampton (CA); Michael Robb Main, Aurora (CA)

(21) Appl. No.: 17/537,255

(22) Filed: Nov. 29, 2021

Related U.S. Application Data
(60) Provisional application No. 63/119,280, filed on Nov. 30, 2020.

(51) Int. Cl. H04N 5/232; G06T 11/60; G06T 7/70; F16M 13/02

(52) U.S. Cl. CPC H04N 5/23299; F16M 13/02; G06T 7/70; G06T 11/60

(57) ABSTRACT

A camera, antenna alignment system and method of aligning an antenna in a reference position, comprising: securing a bracket to one side of the antenna, said bracket including a camera mounting surface remote from said antenna; positioning a camera on said camera mounting surface; and a obtaining an image with a field of view from said camera to obtain data of nearby objects.

### FIELD OF THE INVENTION

The invention relates to a camera, antenna alignment system and method of aligning an antenna in a reference position, comprising: securing a bracket to one side of the antenna, said bracket including a camera mounting surface remote from said antenna; positioning a camera on said camera mounting surface; and a obtaining an image with a field of view from said camera to obtain data of nearby objects so as to minimize blind spots and to determine the potential cause of passive intermodulation (PIM).

### BACKGROUND OF THE INVENTION

Wireless service providers utilize communication antennas on towers, rooftops, buildings, and other tall structures. The radio signal from each communication antenna travel several miles, due to the height of these structures, thereby establishing a geographic area within which service may be provided to customers. Wireless service providers typically install several directional communication antennas per site as multiple directional communication antennas are needed for increased capacity and reception.

Each directional antenna is intended to face a specific direction (referred to as “azimuth”) relative to true north, to be inclined at a specific downward angle with respect to the horizontal in the plane of the azimuth (referred to as “down tilt”) and to be vertically aligned with respect to the horizontal (referred to as “skew”). Undesired changes in azimuth, down tilt, and skew will detrimentally affect the coverage of a directional antenna. In general, the more accurate the installation, the better the network performance that may be achieved within the area served by the antenna. Directional antenna installations are performed by tower companies who use certified tower climbers to carry out these installations.

In addition it is important to align the directional antenna so as to avoid objects in its path that can degrade the quality of the signal and communication due to passive intermodulation and antenna transmission blockage.

Passive intermodulation (PIM) is a form of intermodulation distortion that occurs in passive components such as antennas, cables, connectors, or duplexers with two or more high-power input signals. PIM in the transmission path degrades quality of the wireless communication system.

Intermodulated signals are generated late in the signal path, they cannot be filtered out and may cause more harm than the stronger, but filtered, IM products from active components.

Intermodulation (IM) or intermodulation distortion (IMD) is the amplitude modulation of signals containing two or more different frequencies, caused by nonlinearities or time variance in a system

PIM shows up as a set of unwanted signals created by the mixing of two or more strong RF signals in a nonlinear device, such as a loose or corroded connector, or nearby rust. Other names for PIM include the diode effect and the rusty bolt effect. The problems with PIM are described in the article www.anritsu.com/en-us/test-measurement/technologioes/pim.

There have been a variety of devices and methods deployed in the prior art to improve the alignment of antenna systems and to use cameras in such alignments.

For example U.S. Pat. No. 7,990,325 shows a remote antenna system employing digital imaging means by which the operator can view both the antenna pointing data and the coverage landscape from the antenna radome perspective. The patent also provides a method for antenna positioning data acquisition and positioning control employing remotely acquired image data. In U.S. Pat. No. 7,990,325 the digital imaging means is a permanent camera in an antenna. The camera 105 is disposed at the front of the antenna and centered on it then but suffers from blind spots directly to the side of it.

U.S. Pat. No. 6,587,699 also shows the camera mounted on the antenna. Furthermore this patents relates to equipment and methods for aligning the antennas of two transceivers of a point-to-point wireless millimeter wave communications link and keeping them aligned. Each of two communicating antennas is equipped with a telescopic camera connected to a processor programmed to recognize landscape images. The processors are programmed to remember the pattern of the landscape as it appears when the antennas are aligned. Each of the cameras then view the landscape periodically or continuously and if the landscape in view changes by more than a predetermined amount a signal is provided to indicate a misalignment. An operator can then take corrective action or alternatively the antenna system can be configured for remote or automatic realignment based of feedback from the camera.

U.S. Pat. No. 10,530,051 shows an antenna alignment device includes a handheld enclosure comprising a high-precision GPS receiver, high-precision GPS antennas spaced apart along an enclosure heading, a display, a camera having a central axis aligned with the heading, and a user interface. A circuit board connects these components and has a processor programmed to determine an azimuth of the heading with the receiver and antennas based upon received GPS signals, to show a view of the camera on the display, to depict crosshairs at a display center point superimposed on the view, to receive a target coordinate from a user through the user interface, to calculate a distance between the target coordinate and the heading and, if the distance is short enough to be contained within the view, to superimpose a bullseye upon the display at the target coordinate, and to dynamically move the bullseye on the display as the user moves the enclosure. The camera is in the alignment tool.

For prior art devices that have the camera in a tool such as an alignment tool, close objects will not be seen especially those on the other side of the antenna because the objects will not be in the field of view. That is because the camera is located (for most antennas) in front of the antenna or alignment tool and the field of view for these cameras is not very large; typically 50 degrees.

For prior art devices where the camera is on the antenna the window or lens of the camera can get dirty and obscure an image and therefore require cleaning and there was no tilt/roll sensor in such cameras.

Furthermore in prior art alignment tools, cameras integral with the alignment tool may need to be mounted to the side or even backwards relative the antenna which can cause the camera I view to change and not see in front of the antenna.

In other prior art alignment tools, a separate piece or device is removeably attached to the bracket for attachment to a mobile device, such as a cellphone or tablet, to take an image of a line of sight but is very cumbersome, limited by the device camera, and the camera is not located at an optimum position relative to the antenna. These prior art devices can be found in:
www.multiwavesensors.com/wp-content/uploads/2020/01/8-Smart-Aliqner-Miscellaneous-Options-Course.pdf pages 6-11; and
www.sunsight.com/Downloadfs/AntennaView%20Camera%20Mount%20%20Instructions%20Issue%201.pdf

However these prior art devices show mobile devices that are not disposed in optimal positions so as diminish the camera's field of view.

It is an object of this invention to provide an improved device and method for minimizing blind spots in an antenna alignment system and alert an RF engineer or the like to a possible cause of PIM or antenna transmission blockage should there be a nearby object in the antenna transmission path.

It is another object of this invention to increase the field of view and thus minimize blind spots where objects that can contribute to PIM, cannot be seen.

These and other objects and features will be described in relation to the following summary and description of the drawings.

### SUMMARY OF INVENTION

It is an aspect of this invention to provide a camera on a bracket removeably retaining an antenna in a reference position. In one embodiment the bracket includes a camera mounting surface. In another embodiment the bracket has a first end and a second end wherein the antenna is retained at said first end and said camera mounting surface is disposed at said second end. The camera can be disposed in said camera mounting surface at a position furthest from said first end. The camera may be added to the bracket, or the camera may be integrally added to the bracket.

The invention includes a camera that is integral with the camera mounting surface, a camera that is removeable attachable or securable to a camera mounting surface on a bracket, whether the camera is part of a mobile device such as a iphone or any suitable camera that is removeable attachable or securable to a camera mounting surface.

In one orientation the camera mounting surface is disposed in a vertical position and said camera is centered vertically on said camera mounting surface.

In yet another embodiment the bracket includes a securing means for securing said camera and bracket to said antenna. The securing means can be a ratchet strap or other securing device.

The bracket and camera is selectively secured to one of two opposite sides of the antenna where said camera on said camera mounting surface is disposed at the same vertical position or orientation when secured to one or other of the two opposite sides.

Another aspect of this invention relates to an antenna alignment system, comprising: a bracket having a securing means for securing the antenna in a reference position; a camera with a lens capable of taking an image having a field of view; the bracket including a camera mounting surface at one end of said bracket; said camera secured to said camera mounting surface furthest from said antenna and centered on said mounting surface so that said camera takes a first image with a first field of view when secured to one side of said antenna and takes a second image with a second field of view when the bracket is flipped and secured to the same orientation on an opposite side of said antenna.

In one embodiment the antenna alignment system includes a flip sensor. In another embodiment the bracket includes tilt and roll sensors.

In another embodiment the antenna alignment system includes communication means for the camera to communicate wirelessly to a mobile phone or tablet.

The camera is selected from a group of wide angle lens, zoom lens, fisheye lens and 130 degree of view lens. The camera can comprise a video or image camera.

The bracket can include a display and an alignment tool to display data from the alignment tool and to communicate with the alignment tool.

In one embodiment the securing means comprises a ratchet strap although other securing means are contemplated.

It is a further aspect of this invention to provide a method of obtaining a field of view in an antenna alignment system, comprising: securing a bracket to one side of the antenna, said bracket including a camera mounting surface remote from said antenna; positioning a camera on said camera mounting surface; obtaining an image with field of view from said camera to obtain data of nearby objects

In one embodiment the method includes positioning the camera on said camera mounting surface at a position furthest from said antenna and centered on said cameral mounting surface so as to take:
a) a first image with a first field of view when said bracket is secured to said one side of said antenna; and
b) a second image with a second field of view when said bracket is secured to an opposite side from said one side of said antenna;
   so as to produce a combined image with an increased field of view.

In another embodiment the method includes determining which of said one side or opposite side of the antenna the field of view was taken.

In another embodiment the method includes overlaying antenna emission patterns on said field of view. In a further embodiment the method includes overlaying antenna emission patterns on said first and second fields of view.

In another embodiment of the invention the method includes providing a rangefinder to measure the distance from the antenna to nearby objects in the field of view of the camera image, annotating the distance measurement on the object in the image and comparing with a distance to PIM (DTP) measurement so as to provide data to determine if the object is a likely cause of PIM.

These and other features of the invention will be described in relation to the following drawings and description of the invention.

### IN THE DRAWINGS

FIG. 1 is a drawing of a camera with a field of view disposed on a bracket in accordance with one aspect of this invention.

FIG. 2 is a prior art drawing of a camera disposed at an end of an alignment tool with a small field of view.

FIG. 3 is a prior art block diagram of a camera disposed on an alignment tool on one side of a relatively large antenna with a relatively small field of view.

FIG. 4 is a prior art drawing of a camera disposed on an alignment tool on one side of a relatively medium sized antenna with a relatively small field of view.

FIG. 5 is a prior art drawing of a camera disposed on an alignment tool on one side of a relatively small sized antenna with a relatively small field of view.

FIG. 6 is a representational view of a drawing of one embodiment of the invention with a wide angle field of view.

FIG. 7a and FIG. 7b is a front elevational view and a top plan view of another embodiment of the invention

FIG. 8 is another embodiment of the invention where the camera on the camera mounting surface is selectively secured to one of two opposite sides of the antenna where the camera on mounting surface is disposed on the same vertical position when secured to one or other of the two opposite sides of the antenna.

FIGS. 9a and 9b illustrates that the camera in another embodiment can comprise a mobile device such as an iphone or tablet having a camera function that is removeably attached to the bracket arm by attachment mounts.

### DETAILED DESCRIPTION OF THE INVENTION

Like parts are given like numbers throughout the figures.

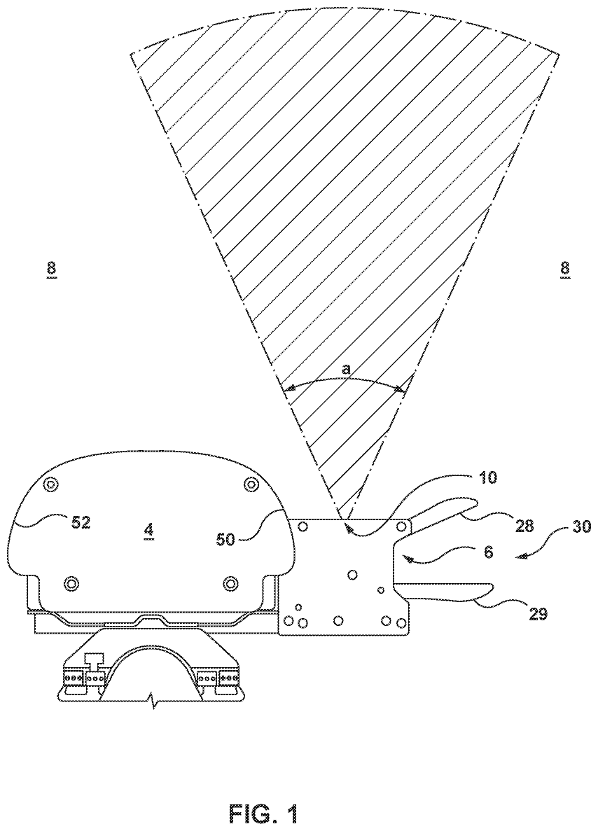

FIG. 1 generally illustrates an embodiment of the invention having a camera 10 disposed on bracket 6. The camera 10 has a lens capable of taking an image which has a field of view such as angle a which for example is 50 degrees.

The bracket 6 may be of the type disclosed in U.S. Pat. No. 8,436,779 where the bracket 6 incorporates a bracket arm 20 which is conformable to one or more walls 22 of the antenna 4. The bracket 6 includes a means to secure the antenna in a reference position and may include an adjustable flexible ratchet strap 5 which is adjustably conformable to one or more of the front antenna wall 24 and side antenna walls 26. The securing means 30 can include a tightening mechanism 30 such as for example tightening arms 28,29 that are adapted to be squeezed together to tighten the flexible ratchet strap 5 to an appropriate tension in relation to the antenna 4, and where the tightening arms 28, 29 may be released in tension. The bracket 6 shown in the figures is just one example of a bracket 6 and alignment tool 12, and other configurations may be used within the scope of this invention.

U.S. Pat. No. 8,436,779 also illustrates an alignment tool 12 which can be used to align the antenna 4. The alignment tool 12 can be used with the bracket 6 as well as by itself.

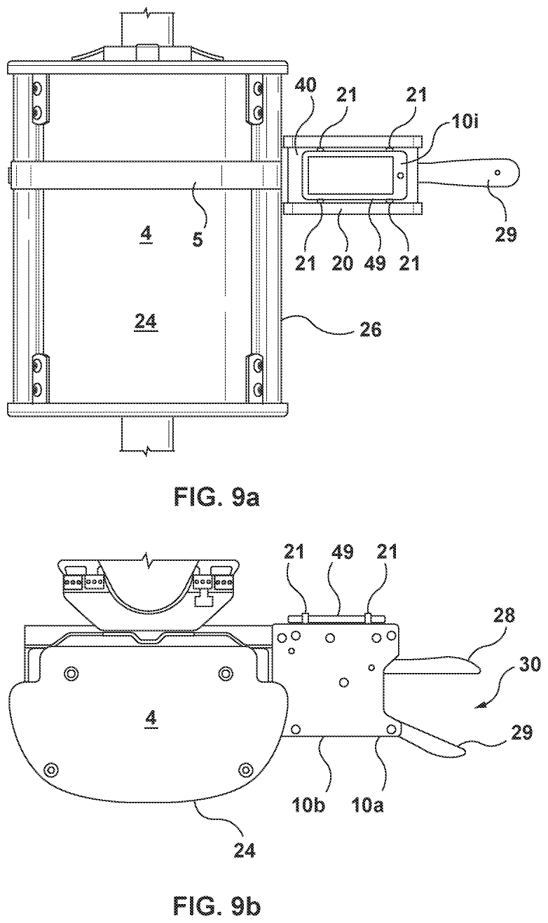

Generally speaking the camera 10 herein is generally described by numeral 10. The camera 10 when described being in a particular position on a camera mounting surface 40 is described as either 10a (in one embodiment disposed in a position remote from the antenna 4) or 10b (in other embodiments centered on the camera mounting surface 40). The invention is described in in reference to one camera 10. Also the camera 10 as described herein can comprise an mobile device 49 such as an iphone or tablet having a camera 10i that is removeably attached to the bracket arm 20 by attachment mounts 21 shown in FIGS. 9a and 9b. In another embodiment the camera 10 in accordance with this invention may be retrofitted into existing brackets 6 in the field with attachment mounts 21 similar to FIGS. 9a and 9b. In other words this invention includes a camera 10 that is integral with the camera mounting surface 40, a camera 10 that is removeable attachable or securable to a camera mounting surface 40 on a bracket 6 whether the camera 6 is part of a mobile device 49 such as a iphone or any suitable camera that is removeable attachable or securable to a camera mounting surface 40.

As mentioned above FIG. 1 shows the use of a camera 10 on a bracket 6 having a relatively small field of view subtended by angle a thus leaving a relatively large blind spot (or dead zone) 8 where the camera 10 cannot see or view any objects 14 or obstructions located in the blind spot which could contribute to PIM or antenna transmission blockage. However by mounting the camera 10 on the camera mounting surface 40 on the bracket 6 the field of view available to detecting PIM is improved over the prior art where cameras are mounted either on the antenna 4 or alignment tool 12.

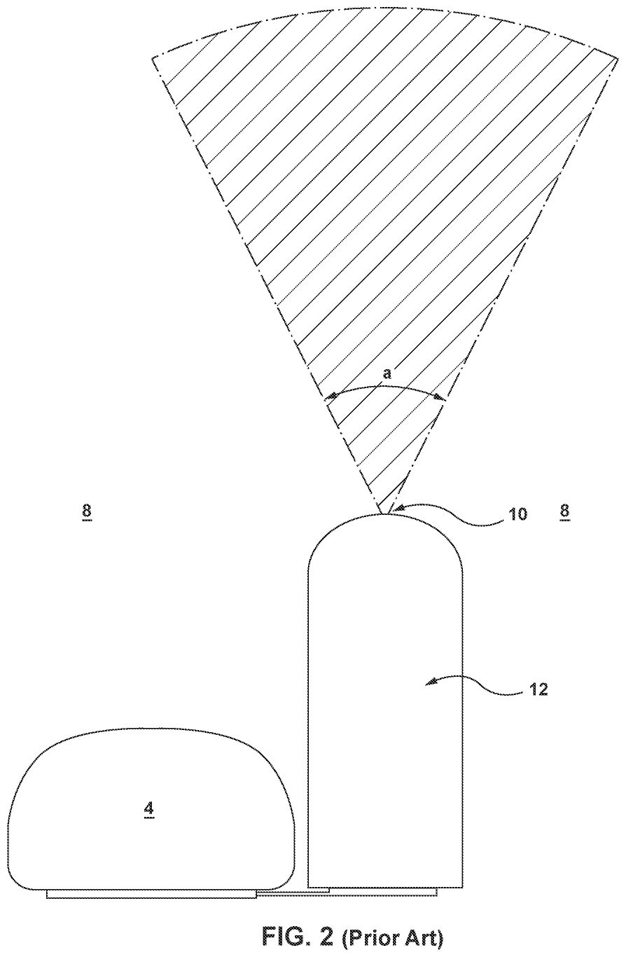

FIG. 2 is a prior art representational drawing of a camera 10 located at an end of an alignment tool 12 having a small viewing angle a of for example 50 degrees, leaving a relatively large blind spot 8 or dead zone 8. One example of the prior art represented in FIG. 2 is from 3Z (trademark)-on-antenna.

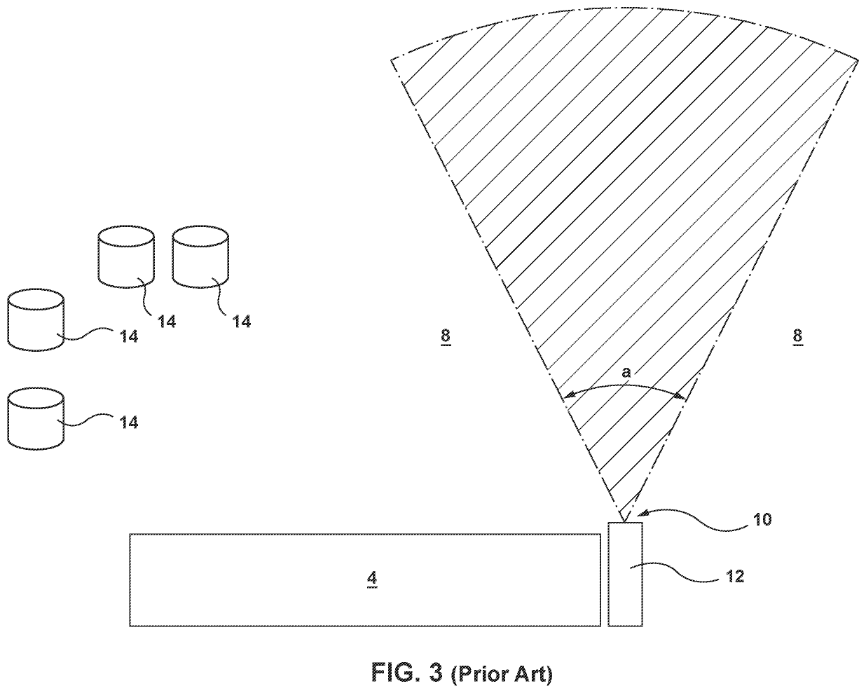

The prior art shown in FIG. 3 relates to a:
Commscope (trademark) model 2X9NPA2010F relatively large antenna configuration, where
   the width of the antenna is 58.5 inches
   the depth of the antenna is 11.4 inches
   the height of the antenna is 69.7 inches
      and a prior art alignment tool such as the 3Z (trademark) alignment tool. The camera is located 2.8 inches to the side of the antenna and 13 inches from the back of a bracket 6 (not shown). Objects 14 in the blind spot 8 either in front of the antenna 4 or off to the side will not be seen by the camera 10. These objects 14 can contribute to PIM or antenna transmission blockage.

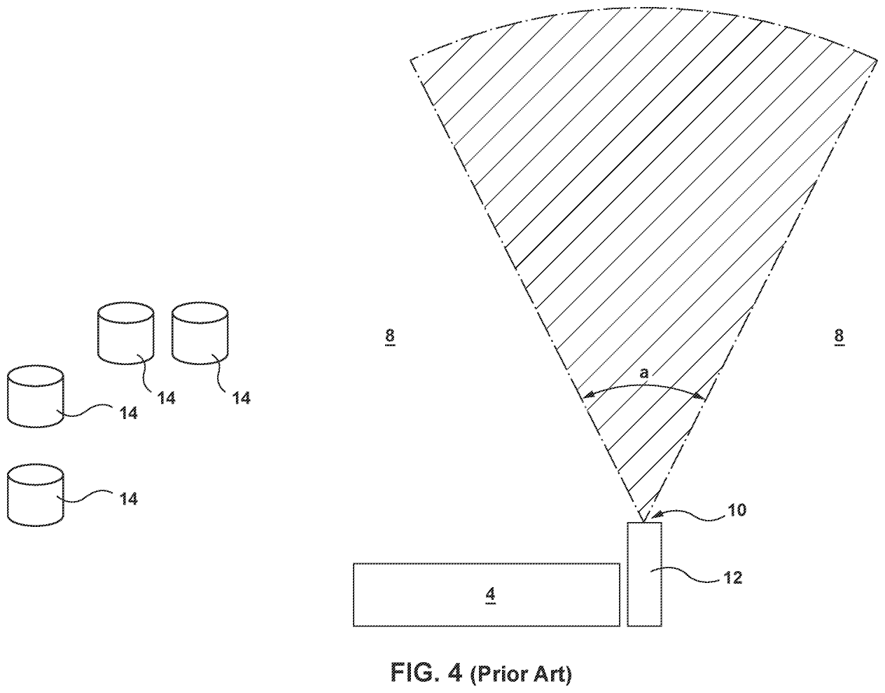

The prior art shown in FIG. 4 relates to a:
Commscope (trademark) model 5N1006F relatively medium sized antenna configuration, where
   the width of the antenna is 34.06 inches
   the depth of the antenna is 7.95 inches
   the height of the antenna is 35 inches
      and a prior art alignment tool such as the 3Z (trademark) alignment tool as described in FIG. 2.

The camera is located 2.8 inches to the side of the antenna and 13 inches from the back of a bracket 6 (not shown). Objects 14 in the blind spot 8 either in front of the antenna 4 or off to the side will not be seen by the camera 10. These objects 14 can contribute to PIM or antenna transmission blockage.

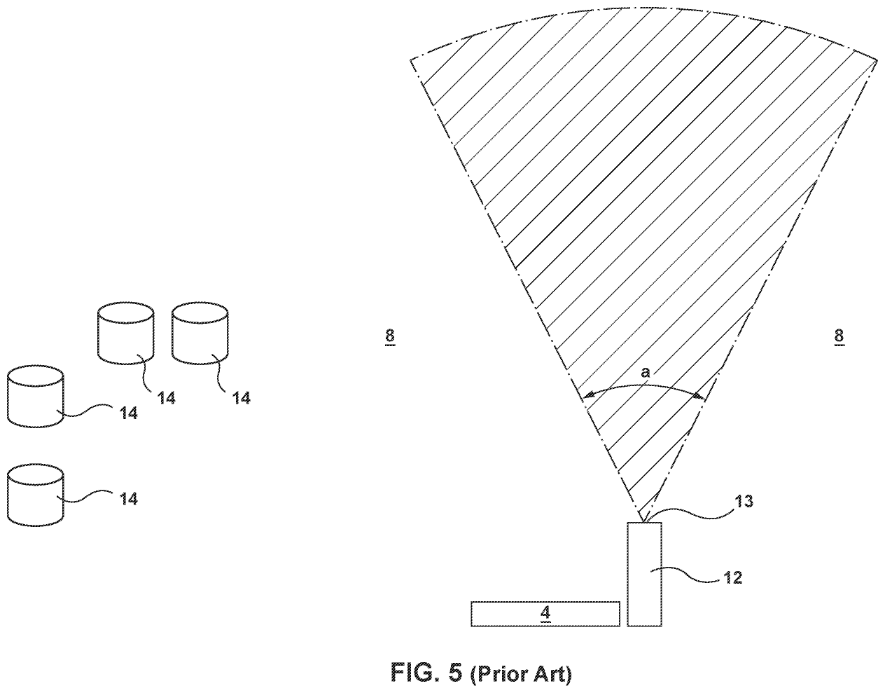

FIG. 5 is another prior art configuration where the camera 10 is located at one end 13 of the alignment tool 12 connected to a relatively small antenna 4.

The prior art shown in FIG. 5 relates to a:
Commscope (trademark) model HBXXX-6516DS-VTM relatively small sized antenna configuration, where
   the width of the antenna is 19.68 inches
   the depth of the antenna is 3.54 inches
   the height of the antenna is 51 inches
      and an alignment tool such as the 3Z (trademark) alignment tool. The camera is located 2.8 inches to the side of the antenna and 13 inches from the back of a bracket 6 (not shown). Objects 14 in the blind spot 8 either in front of the antenna 4 or off to the side will not be seen by the camera 10. These objects 14 can contribute to PIM or antenna transmission blockage.

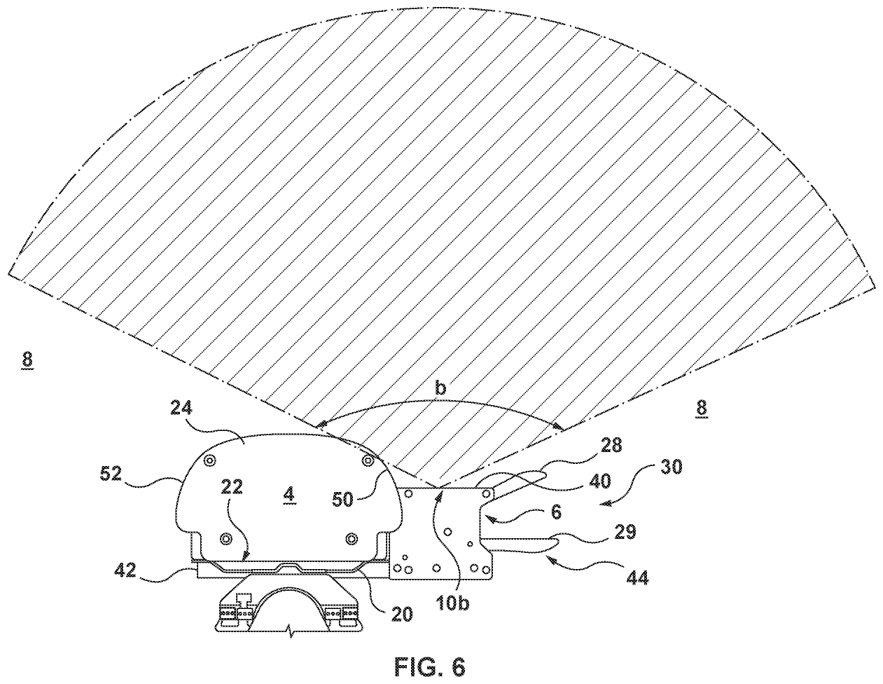

FIG. 6 is a drawing of another embodiment of the invention with a wide angle field of view. As shown in FIG. 6 a camera 10b is integral with the bracket 6 where the bracket 6 is removeably securable to an antenna 4 in a reference position by squeezing tightening arms 28,29 that are adapted to tighten the flexible ratchet strap 5 to an appropriate tension in relation to the antenna 4, and where the tightening arms 28, 29 may be released in tension.

The bracket 6 includes a camera mounting surface 40 which faces in the same direction as the front antenna wall 24. The bracket 6 has a first end 42 and a second end 44. In one configuration (FIG. 6 is a top plan view) where the antenna 4 is shown in a vertical position and the camera mounting surface 40 is also disposed in a vertical plane. The antenna 4 is shown at one end 42 of bracket 6 while the camera mounting surface 40 is shown disposed at the second end 44 of the bracket 6 in a region remote from the antenna 4.

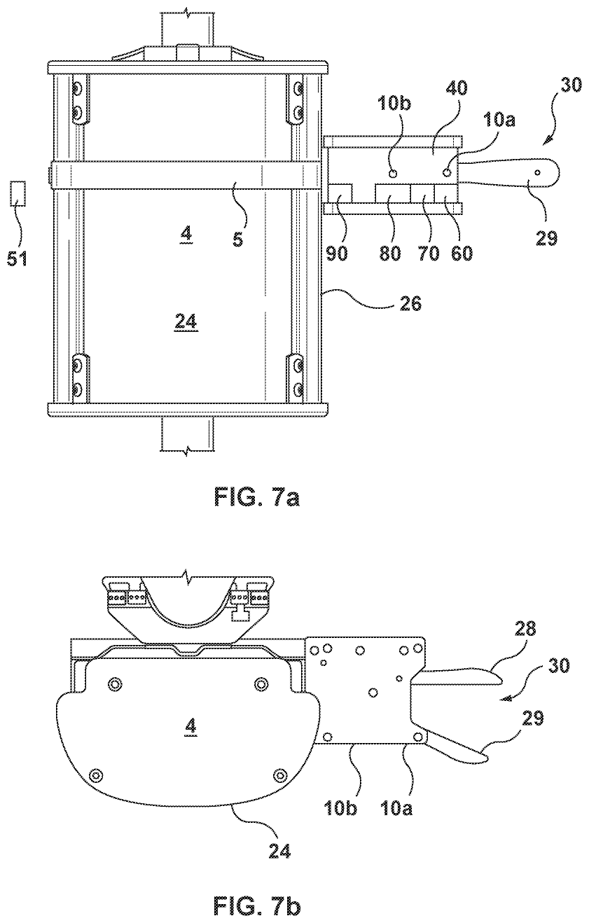

When the camera 10 is disposed on the bracket 6 at a position remote from the first end 42 as seen in FIG. 6 the image taken by the camera 10 has field of view b that is shifted to the side as shown thus maximizing the camera viewing area or volume subtended by an angle b, to the side of the antenna, thus minimizing the blind spot or dead zone to that side. In one embodiment of the invention the camera 10 is disposed on the camera mounting surface. In another embodiment shown in FIGS. 7a and 7b the camera 10 is positioned 5 inches to the side of the antenna 4 and 3.8 inches from a backchannel of the bracket 6.

In other words the field of view of a particular camera 10 is fixed for that camera. So by shifting the camera 10 field of view to the side 50 of an antenna 4 this positioning increases the field of view or viewing area b on that side 50 of the antenna 4.

The antenna 4 is primarily vertically oriented. Alternatively the antenna 4 may possibly be disposed in other positions such as horizontally.

When the camera mounting surface 40 is disposed in a vertical position the camera 10b in one embodiment has a lens which is centered vertically on the camera mounting surface 40 as shown in FIG. 7a. FIG. 7a also shows that in another embodiment the camera 10b has a lens which is centered both vertically and horizontally on camera mounting surface 40. In another embodiment the camera 10 has a lens disposed to the furthest side of the camera represented by 10a.

In another embodiment the camera 10 comprises a wide angle lens greater than 50 degrees. Various embodiments of the invention relate to a camera 10 selected from the group of wide angle lens, zoom lens, fisheye lens and 130 degree of view lens.

As can be seen by using a wide angle lens in the camera 10 the camera viewing area subtended by angle b is increased which will minimize the blind spot 8. More specifically the camera viewing area or field of view is a volume, or a camera viewing cone (in 3 dimensions)

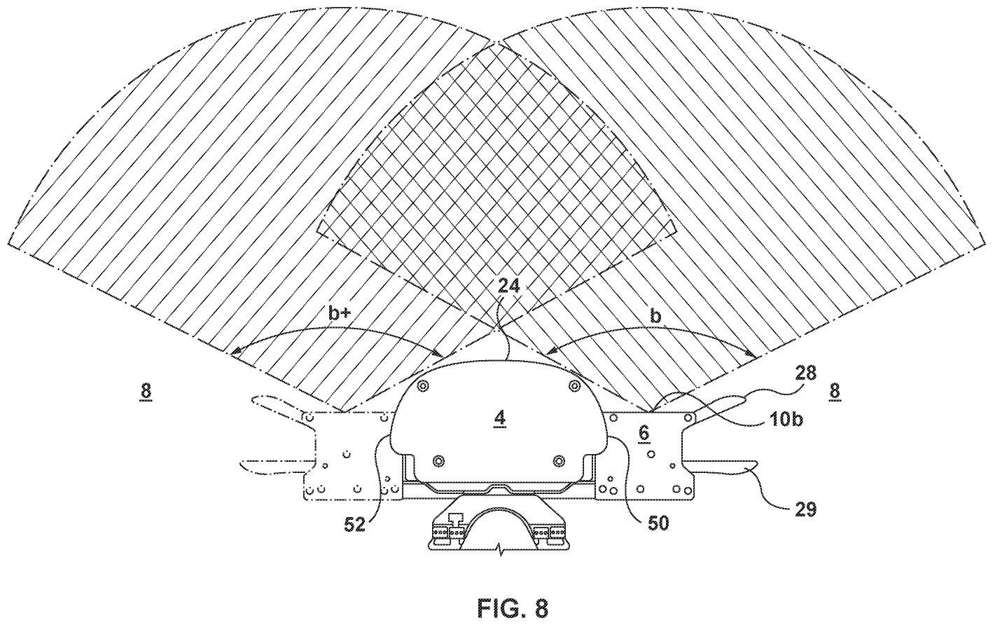

In another embodiment shown in FIG. 8 the bracket 6 (with camera 10b on the camera mounting surface 40) is first secured to one side 50 of the antenna 4 and a first image taken with a first field of view b; and then the bracket 6 is removed and secured to the other side 52 of the antenna 4 and a second image with a second field of view b+ is taken. In this configuration the field of view becomes increased as a result of the overlapping angles b overlapping b+ (because we are using the same camera 10b which in most embodiments will have the same angle for its field of view where b=b+ when moving from side 50 to side 52. There are however cameras that have variable field of view angles such as telescoping lens where b can be different from b+) and which further shows more possible nearby objects in the antenna transmission path; in which event an alert is provided to an RF engineer or the like of a possible cause of PIM or antenna transmission blockage. If so an individual will be dispatched to investigate and possibly realign the antenna. In this embodiment angle b equals angle b+ because the same camera with a lens is used. It is possible that if a camera with a variable lens such as a telescoping lens is used that is activated remotely by wireless means that angle b is different from angle b+

In other words the camera 10b mounted on the mounting surface 40 is disposed in one embodiment in the middle of the camera mounting surface 40 (see FIGS. 6 and 8) so that the camera 10 will be disposed on the same vertical position from ground level. In other words as shown in FIG. 8 the bracket is first secured to one side 50 of the antenna 4 to record a first image with a field of view image subtended by angle b; the bracket 6 is then removed to be then secured to the other side 52 of antenna 4 (shown in phantom lines) to record a second image with a second field image subtended by angle b+. The two images can be stored in for example in a computer memory and software available to store the combined fields of view subtended by and b and overlapping angle b+. As mentioned these two angles b and b+ are the same but the field of view is broadened (increased in the horizontal direction as shown in FIG. 8). In other words when the camera 10 is disposed in the middle of the camera mounting surface 40 the field of view subtended by angles b and b+ will be at the same vertical position or height from ground level.

Not only does the invention relate in one embodiment to the camera 10a being disposed at a position on the camera mounting surface 40 remote from one end of the bracket 6 as shown in FIG. 7a but also in other embodiments the camera 10b is disposed in the middle of camera mounting surface 40 as shown in FIGS. 7a and 8 where the field of view has been increased from the subtended angle b to a field of view comprising the combination of angle b and b+. Angles b and b+ are the same.

The drawings show an antenna alignment system, comprising:
a) a bracket 6 having a securing means 30 for securing the antenna 4 in a reference position;
b) a camera 10 to take an image having a field of view;
c) the bracket 6 includes a mounting surface 40 at one end of the bracket 6;
d) the camera 10 secured to the camera mounting surface 40 furthest from said antenna 4 and centered on the mounting surface 40 so that said camera 10 has a first field of view when secured to one side 50 of said antenna 4 and a second field of view when the bracket 4 is flipped and secured to the same orientation on an opposite side 52 of the antenna 4.

In one embodiment the antenna alignment system includes a flip sensor 90 so as to determine when the bracket 6 is flipped from one side 50 of the antenna 4 to the other side 52 of the antenna. In another embodiment of the invention the bracket 6 includes tilt and roll sensors 60.

In a further embodiment the bracket 6 includes communication means 70 for the camera 10 to communicate wirelessly to a mobile phone or tablet (not shown knowledge), in a manner well known to those persons skilled in the art including low energy Bluetooth.

in another embodiment the bracket 6 includes a display 80 and an alignment tool 12 to display data from the alignment tool 12 and to communicate with the alignment tool 12.

The invention described herein also shows a method of obtaining a field of view in an antenna alignment system, comprising:
a) securing a bracket 6 to one side 50 of the antenna 4, said bracket including a camera mounting surface 40 remote from said antenna 4;
b) positioning a camera 10 on said camera mounting surface 40;
c) obtaining an image having a field of view from said camera 10 to obtain data of nearby objects 14.

In another embodiment the method includes positioning the camera 10 on said camera mounting surface 40 at a position furthest from said antenna 6 and centered on said camera mounting surface 40 so take:
a) a first field of view image when said bracket 6 is secured to said one side 50 of said antenna; and
b) a second field of view image when said bracket 6 is secured to an opposite side 52 from said one side 50 of said antenna 4 so as to produce an image with an increased field of view.

The invention also includes a method where;
a a camera 10 is positioned on a bracket 6;
b attaching the bracket 6 to an antenna 4;
c attaching an alignment tool 12 to the bracket 6 to align the antenna 4 to a selected azimuth, tilt and roll;
d removing the alignment tool 12 from the bracket 6;
e taking an image with the camera 6 to one side of the antenna.

In a further embodiment the invention relates to also taking a second image with the camera 10 from the other side of the antenna.

The invention also includes the method including the step of providing a rangefinder 51 to measure the distance from the antenna to nearby objects in the field of view of the camera image, annotating the distance measurement on the object in the image and comparing with a distance to PIM (DTP) measurement so as to provide data to determine if the object is a likely cause of PIM. One such device that can provide an individual with a distance to PIM (DTP) measurement is an Anritsu (trademark) PIM Master model MW82119B. The rangefinder 51 is handheld near the antenna 4 by an individual and aimed at different objects to provide a DTP measurement.

The method includes computer means to determine which of said one side 50 or opposite side 52 of the antenna 4 the field of view was taken. In yet another embodiment the method includes overlaying antenna emission patterns on said field of view; which method includes overlaying antenna emission patterns on said first and second fields of view.

What is claimed:

1. A camera on a bracket, where said bracket is removeably retaining an antenna in a reference position.

2. The camera as claimed in claim 1 wherein said bracket includes a camera mounting surface.

3. The camera as claimed in claim 2 wherein said bracket has a first end and a second end wherein said antenna is retained at said first end and said camera mounting surface is disposed at said second end.

4. The camera as claimed in claim 3 wherein said camera is disposed on said camera mounting surface at a position furthest from said first end.

5. The camera as claimed in claim 4 wherein said camera mounting surface is disposed in a vertical position and said camera is centered vertically on said camera mounting surface.

6. The camera as claimed in claim 5 wherein said bracket includes a securing means for securing said camera and bracket to said antenna.

7. The camera as claimed in claim 6 wherein said bracket and camera is selectively secured to one of two opposite sides of the antenna where said camera on said camera mounting surface is disposed at the same vertical position when secured to the one or other of the two opposite sides of the antenna.

8. The camera as claimed in claim 1 wherein said camera is integral with said bracket.

9. The camera as claimed in claim 1 wherein said camera is releaseably securable to said bracket.

10. The camera as claimed in claim 7 wherein said camera comprises a wide angle lens.

11. An antenna alignment system, comprising:
a) a bracket having a securing means for securing the antenna in a reference position;
b) a camera for taking an image with a field of view;
c) the bracket including a camera mounting surface at one end of said bracket;
d) said camera secured to said camera mounting surface furthest from said antenna and centered on said mounting surface so that said camera takes a first image having a first field of view when secured to one side of said antenna and takes a second image having a second field of view when the bracket is flipped and secured to the same orientation on an opposite side of said antenna; and
e) an antenna alignment tool.

12. The antenna alignment system as claimed in claim 11 including a flip sensor.

13. The antenna alignment system as claimed in claim 12 wherein the bracket includes tilt and roll sensors.

14. The antenna alignment system as claimed in claim 12 including communication means for said camera to communicate wirelessly to a mobile phone or tablet.

15. The antenna alignment system as claimed in claim 14 wherein said camera is selected from a group of wide angle lens, zoom lens, fisheye lens and 130 degree of view lens.

16. The antenna alignment system as claimed in claim 15 wherein said bracket includes a display to display data from the alignment tool and to communicate with the alignment tool.

17. A method of obtaining a field of view in an antenna alignment system: comprising:
a) securing a bracket to one side of the antenna, said bracket including a camera mounting surface remote from said antenna;
b) positioning a camera on said camera mounting surface;
c) obtaining an image having a field of view from said camera to obtain data of nearby objects.

18. The method as claimed in claim 16 including: positioning the camera on said camera mounting surface at a position furthest from said antenna and centered on said cameral mounting surface so take:
a) a first image with a first field of view when said bracket is secured to said one side of said antenna; and
b) a second image with a second field of view when said bracket is secured to an opposite side from said one side of said antenna;
so as to produce an image with an increased field of view.

19. The method as claimed in claim 17 including determining which of said one side or opposite side of the antenna the field of view was taken.

20. The method as claimed in claim 16 including overlaying antenna emission patterns on said field of view.

21. The method as claimed in claim 16 including overlaying antenna emission patterns on said first and second fields of view.

22. The method as claimed in claim 16 including providing a rangefinder to measure the distance from the antenna to nearby objects in the field of view of the camera image, then, annotating the distance measurement on the object in the image and comparing with a distance to PIM (DTP) measurement so as to provide data to determine if the object is a likely cause of PIM.
